(19) United States
(12) Patent Application Publication
(10) Pub. No.: US 2014/0313324 A1
(43) Pub. Date: Oct. 23, 2014

(54) DYNAMIC RESULTS PROJECTION FOR MOVING TEST OBJECT

(71) Applicant: SIEMENS AKTIENGESELLSHAFT, München (DE)

(72) Inventors: Lukasz Adam Bienkowski, Munich (DE); Christian Homma, Vaterstetten (DE); Hubert Mooshofer, Munich (DE); Max Rothenfusser, Munich (DE)

(21) Appl. No.: 14/365,960

(22) PCT Filed: Dec. 3, 2012
(86) PCT No.: PCT/EP2012/074196

§ 371 Date: Jun. 16, 2014

(30) Foreign Application Priority Data
Dec. 16, 2011 (DE) 10 2011 088 837.3

(51) Int. Cl. G06T 7/00; G06T 7/20; H04N 5/33

(52) U.S. Cl. CPC G06T 7/0042; H04N 5/33; G06T 7/2093
USPC 348/135

(57) ABSTRACT

Active thermography is used for evaluating a moving test object by detecting a test image of a test object and ascertaining a position of the test object in three-dimensional space. A thermographic test image is adapted with respect to the test image perspective and position and is congruently projected onto the test object.

### CROSS REFERENCE TO RELATED APPLICATIONS

This application is the U.S. national stage of International Application No. PCT/EP2012/074196, filed Dec. 3, 2012 and claims the benefit thereof. The International Application claims the benefit of German Application No. 102011088837.3 filed on Dec. 16, 2011, both applications are incorporated by reference herein in their entirety.

### BACKGROUND

Described below are a system and a method for evaluating a moving test object by active thermography.

An extension of so-called active thermography is known in which both a projection of thermographic data to an device under test, and an interaction with the projected thermographic data can be executed. In this extension, an evaluation of results does not take place, as known in active thermography, on the computer screen, but in a simplified fashion directly at the device under test. In this case, a device under test remains fixed so that the position of a projection image and of a test part correspond. A change in position of a device under test, for example in order to improve viewing conditions, is therefore not possible. This problem constitutes a limitation in the evaluation process. All that is known is a projection technique for a stationary case, that is to say for an immovable test part.

Known methods already allow direct evaluation at the test object. It is therefore no longer necessary to assess defects on the screen or to manually transfer them onto the test object. Since the test object is clamped in the measurement apparatus during the entire evaluation process and must therefore remain immovable, the tester may be impeded and spatially restricted by the measurement apparatus. Not infrequently, the clamped test object is not freely accessible, and so an evaluation of results is substantially more difficult.

### SUMMARY

In the aspects described below, an arrangement and a method obtain a thermographic test image on a moving test object. For example, the aim is for it to be possible to locate anomalies on a moving real test object. The aim is to render it possible to move a test part during a projection in order to improve its evaluation process.

In accordance with a first aspect, an arrangement is provided for evaluating a moving test object by active thermography, the arrangement having the following devices: a first detecting device for detecting a thermographic test image of the test object; a second detecting device for detecting three-dimensional surface coordinates of the test object; a computing device for adapting the thermographic test image to the test object with the aid of the three-dimensional surface data of the test object; a third detecting device for detecting a respective position of the test object in three-dimensional space; the computing device for adapting the thermographic test image with regard to its perspective and its position with the aid of the respective detected position of the test object; and a projection unit for congruently projecting onto the test object the thermographic test image adapted to the moving test object.

In accordance with a second aspect, a method is provided for evaluating a moving test object by active thermography using a first detecting device to detect a thermographic test image of the test object; a second detecting device to detect three-dimensional surface coordinates of the test object; a computing device to adapt the thermographic test image to the test object with the aid of the three-dimensional surface data of the test object; and a third detecting device to detect a respective position of the test object in three-dimensional space. The computing device is also used to adapt the thermographic test image with regard to its perspective and its position with the aid of the respective position of the test object; and a projection unit is used for congruently projecting the thermographic test image, adapted to the moving test object, onto the test object.

The position of a test object can be determined by using an adapted depth sensor camera. With the aid of the 3D position, the projection image is adapted by corresponding perspective correction and positioning in such a way that it congruently adapts to the device under test upon subsequent projection, for example by a beamer.

The method enables the tester to freely place and move a test object so that, for example, it is possible to effect more favorable light conditions, or an advantageous viewing angle for the evaluation. A resulting complete decoupling of the test object from the measurement arrangement effects unrestricted freedom of view onto and around the test object. Quality of evaluation is effectively increased in this way.

In accordance with an advantageous refinement, the third detecting device can have an infrared camera or a depth sensor camera. In this way, the third detecting device can easily be integrated into the first or second detecting device.

In accordance with a further advantageous refinement, the third detecting device can have a cage in which the test object is fixed relative to markings of the cage, and can detect the respective positions of the markings. Determining the position is simplified.

In accordance with a further advantageous refinement, the third detecting device can have identification marks, for example so-called 2D data matrix codes, fixed on the test object. In this way, the third detecting device can be, in particular, a camera.

In accordance with a further advantageous refinement, the third detecting device can have a robot arm, having markings or sensors, on which the test object is fixed, and the detecting device can detect the respective positions of the markings or sensors.

In accordance with a further advantageous refinement, the third detecting device can have a position and orientation sensor that is fixed on the test object, and the detecting device can detect respective position data of the sensor.

In accordance with a further advantageous refinement, the third detecting device can have two depth sensor cameras of which the first detects a change in position, and the second detects a new position.

In accordance with a further advantageous refinement, the computing device can adapt the thermographic test image as a function of a respective position of the test object by a mathematical 3D transformation.

In accordance with a further advantageous refinement, the second detecting device can detect the three-dimensional surface coordinates, likewise by the depth sensor camera. A depth sensor camera can detect three-dimensional surface coordinates of the test object in particular by strip light projection or laser section. A depth sensor camera can likewise detect a position of a test object.

In accordance with a further advantageous refinement, the second detecting device can detect the three-dimensional surface coordinates by distance measurements.

In accordance with a further advantageous refinement, the projection unit can be a beamer.

In accordance with a further advantageous refinement, the cage can additionally have control elements for switching functions.

In accordance with a further advantageous refinement, a function can be a contrast adaptation, a change in a color palette, a switchover between views of a test result, or a scrolling down.

In accordance with a further advantageous refinement, the method can be continuously repeated to detect each change in a position of the test object.

In accordance with a further advantageous refinement, the test object can be moved manually in three-dimensional space.

In accordance with a further advantageous refinement, it is possible to provide the third detecting device by a first depth sensor camera for detecting a change in position, and by a second depth sensor camera for detecting an end position of a test object from a plurality of test objects last arranged on a test table.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a perspective view/block diagram of a first exemplary embodiment;

FIG. 2 is a perspective view of a second exemplary embodiment;

FIG. 3 is a perspective view of a third exemplary embodiment;

FIG. 4 is a perspective view of a fourth exemplary embodiment; and

FIG. 5 is a flowchart of an exemplary embodiment of the method.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

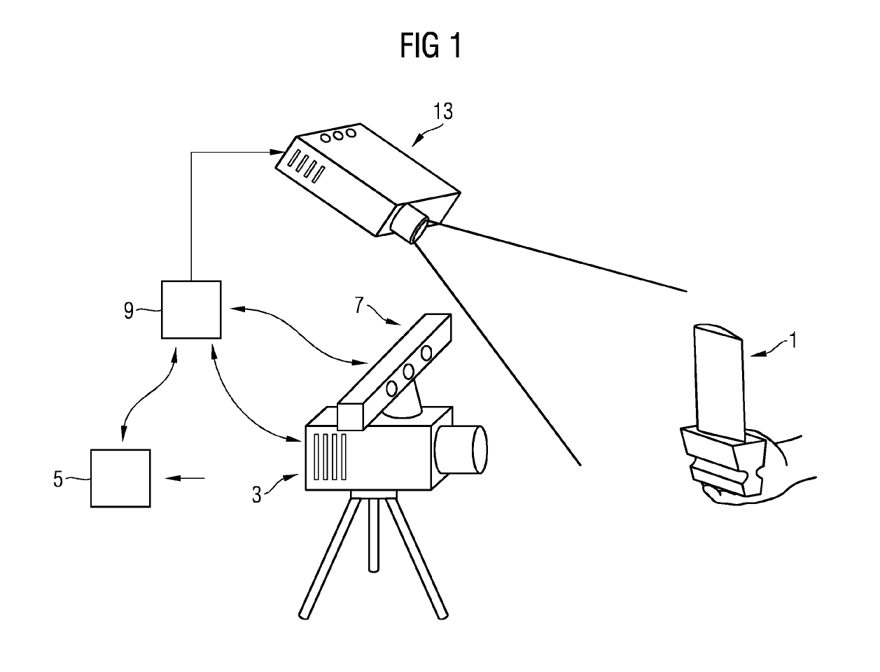

FIG. 1 shows a first exemplary embodiment. The arrangement for evaluating a moving test object 1 by active thermography has a first detecting device 3 for detecting a thermographic test image 5 of the test object 1. It is particularly advantageous for such a first detecting device 3 to be a thermal imaging camera. In addition, the arrangement has a second detecting device 7 for detecting three-dimensional surface coordinates of the test object 1. It is particularly advantageous for such a second detecting device 7 to be designed as a depth sensor camera. A computing device 9 executes an adaptation of the thermographic test image 5 to the test object 1 with the aid of the three-dimensional surface data of the test object 1. In addition, a respective position of the test object 1 is detected in three-dimensional space by a third detecting device 15. It is particularly advantageous for such a third detecting device 15 to be provided by the first detecting device 3 or the second detecting device 7. With the aid of the respective detected positions of the test object 1, the computing device 9 can now adapt the thermographic test image 5 with regard to its perspective and its position so that a projection unit 13 for congruently projecting onto the test object 1 the thermographic test image 5 adapted to the moving test object 1 can congruently project. In accordance with this exemplary embodiment, an arrangement has a thermal imaging camera, a depth sensor camera and a beamer. A 3D data record of a test part can be detected by the depth sensor camera. With the aid of the 3D data record on a computer, the thermal image is adapted to the device under test and its position by a mathematical 3D transformation. The thermal image is subsequently projected onto the test part. In accordance with the first exemplary embodiment, a test object 1 is held in a hand during an evaluation. The test object 1, which can likewise be denoted as device under test, can be, for example, a turbine blade which can be held by a tester in his hand during evaluation and be moved freely in space. The depth sensor camera continuously detects the 3D data record of the device under test, as a result of which the position of the test part in space is determined. The transformed and adapted measurement result image is projected onto the test part.

As an alternative to this first exemplary embodiment, it is possible to determine the position of the test object 1 by a position and orientation sensor which is fastened on the test object 1 and, for example, provides position information by radio. The test object 1 can be moved freely in space by the tester, it being possible for a transformed and adapted measurement result image to be easily projected, in turn, onto the test object 1.

Moreover, it is also possible as an alternative for markers which can be imaged with the aid of a camera, data matrix codes, for example, to be applied to the test object 1 in order that the latter can be tracked in space.

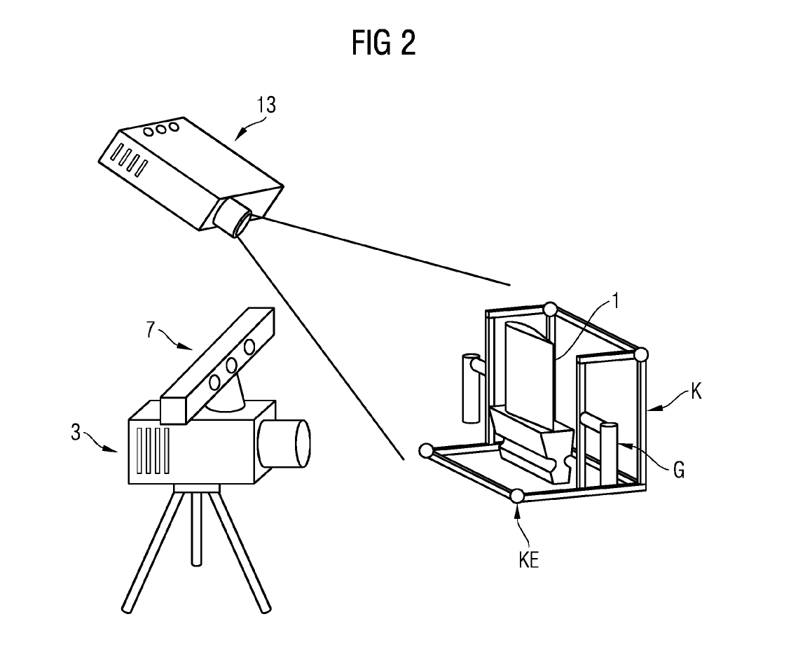

FIG. 2 shows a second exemplary embodiment. In this case, the arrangement in accordance with FIG. 2 corresponds to the arrangement in accordance with FIG. 1, with the difference that, in order to simplify the determination of the position of the test object 1, and to reduce a computational outlay of the computing device 9, the test object 1 is fastened in a cage K and can be moved only with the latter. The position of the test object 1 in the cage K remains unchanged during the evaluation. Located at the cage corners KE are markers whose positions are detected by a depth sensor camera 7. The position of the test object 1 can be calculated therefrom in a simplified way. In addition, the cage K has handles G, it being possible to switch various functions by turning the cage handles, this being able to be, for example, contrast adaptation, changing of a color palette, switching over between various views of a test result or scrolling down. Scrolling down corresponds largely to so-called zooming.

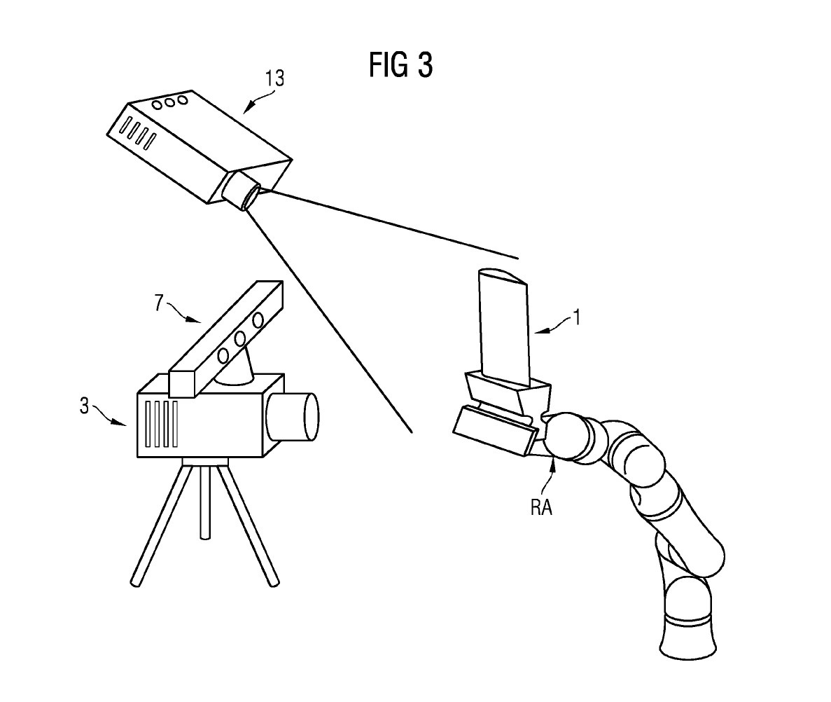

FIG. 3 shows a third exemplary embodiment. In accordance with the exemplary embodiment, the test object 1 is held on a robot arm RA. The robot arm RA can be moved freely in space by only a small force by using so-called automatic gravitation compensation. This is an advantage when investigating heavy test objects 1 which would otherwise quickly lead to fatiguing the tester. Position in space is determined by markers on the robot arm which can be detected by the depth sensor camera 7, and/or based on information from robot sensors.

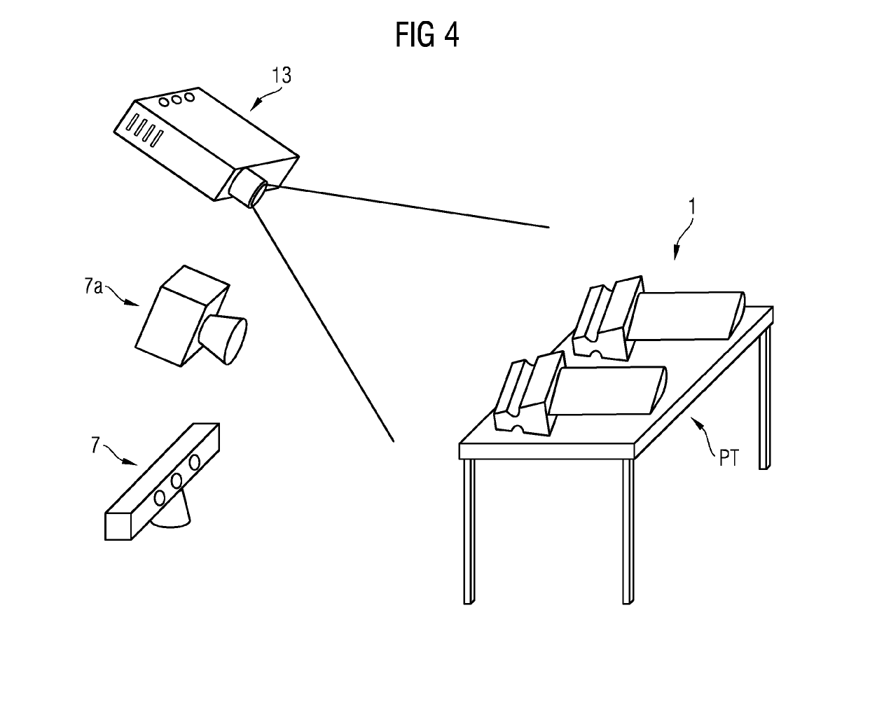

FIG. 4 shows a fourth exemplary embodiment. After a measurement, the test object 1 is placed on a test table PT. In accordance with the exemplary embodiment, use is made of two depth sensor cameras 7 and 7a: a relatively accurate first depth sensor camera 7, which can likewise operate in the visible light spectrum, and a relatively coarse cost effective depth sensor camera 7a. In order to ensure maximum accuracy in the projection, use is made of the relatively accurate depth sensor camera 7 to recognize position. Each change in position is detected, in turn, by the relatively inaccurate depth sensor camera 7a which continually monitors the test object 1 in the invisible light spectrum. As soon as a change in position is recognized, the relatively accurate depth sensor camera 7 switches on in order to determine the new position relatively accurately and adapt the projection. A plurality of test objects 1 can be located, and evaluated, on the test table PT at the same time.

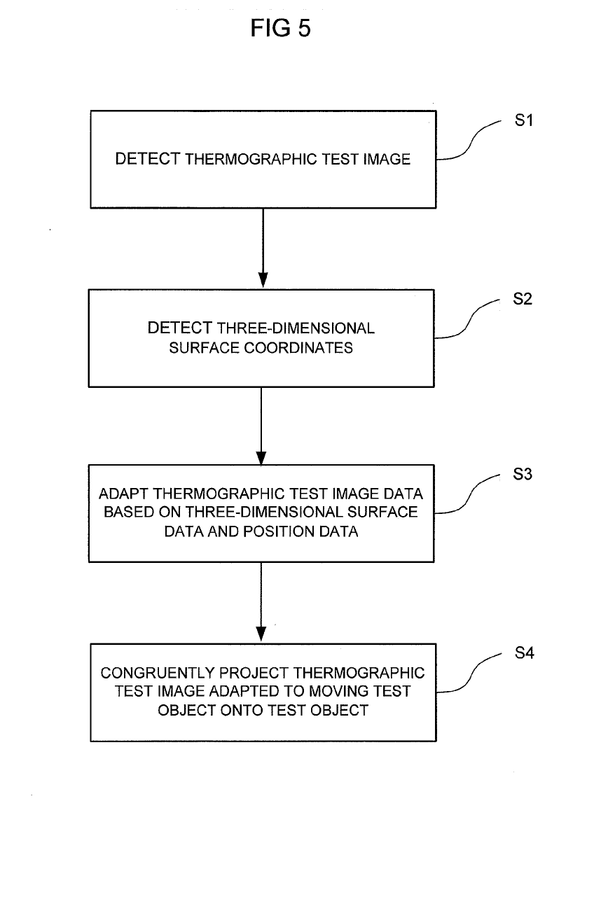

FIG. 5 shows an exemplary embodiment of the method. Such a method for evaluating a moving test object 1 by active thermography may include the following: in S1 a thermographic test image of the test object is detected by a first detecting device. In S2, a second detecting device is used to detect three-dimensional surface coordinates of the test object and respective positions of the test object in three-dimensional space. In S3, a computing device is used to adapt the thermographic test image data with the aid of the three-dimensional surface data and the position data of the test object. In S4, a projection unit is used to congruently project the thermographic test image adapted to the moving test object onto the test object. Such an evaluation operation can be executed continuously, with particular advantage, so as always to ensure no error in projecting after a change in position of the test object.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-18. (canceled)

19. A system for evaluating a moving test object by active thermography, comprising:
a first detecting device detecting a thermographic test image of the test object;
a second detecting device detecting three-dimensional surface coordinates of the test object;
a third detecting device detecting a respective position of the test object in three-dimensional space;
a computing device adapting the thermographic test image to the test object based on the three-dimensional surface coordinates of the test object; with regard to a perspective and the respective position of the test object; and
a projection unit congruently projecting onto the test object the thermographic test image adapted to the test object during movement thereof.

20. The system as claimed in claim 19, wherein the third detecting device is provided by at least one of the first and second detecting devices.

21. The system as claimed in claim 19, wherein the third detecting device has a cage in which the test object is fixed relative to markings of the cage, and detects respective positions of the markings.

22. The system as claimed in claim 21, wherein the cage has control elements for switching functions.

23. The system as claimed in claim 21, wherein the third detecting device uses identification marks fixed on the test object, and includes a camera detecting visible light.

24. The system as claimed in claim 23, wherein the identification marks are 2D data matrix codes.

25. The system as claimed in claim 19, wherein the third detecting device includes a robot arm, having markings or sensors, on which the test object is fixed, and the detecting device detects the respective positions of the markings or sensors.

26. The system as claimed in claim 25,
further comprising a position and orientation sensor fixed on the test object, and
wherein the detecting device detects respective position data of the sensor.

27. The system as claimed in claim 26, wherein the third detecting device includes a first depth sensor camera detecting a change in position, and a second depth sensor camera detecting a new position.

28. The system as claimed in claim 27, wherein the computing device adapts the thermographic test image as a function of a respective position of the test object by a mathematical 3D transformation.

29. The system as claimed in claim 28, wherein the first detecting device is a thermal imaging camera, and the second detecting device is a depth sensor camera.

30. The system as claimed in claim 29, wherein the second detecting device detects the three-dimensional surface coordinates by distance measurements.

31. The system as claimed in claim 30, wherein the projection unit is a beamer.

32. The system as claimed in claim 31, wherein the function is at least one of a contrast adaptation, a change in a color palette, a switchover between views of a test result, and a scrolling down.

33. A method for evaluating a moving test object by active thermography, comprising:
detecting a thermographic test image of the test object by a first detecting device;
detecting three-dimensional surface coordinates of the test object by a second detecting device;
detecting a respective position of the test object in three-dimensional space by a third detecting device;
adapting the thermographic test image to the test object by a computing device based on the three-dimensional surface coordinates of the test object with regard to a perspective and the respective position of the test object; and
congruently projecting the thermographic test image, adapted to the moving test object, onto the test object by a projection unit.

34. The method as claimed in claim 33, wherein said adapting of the thermographic test image as a function of the respective position of the test object uses a mathematical 3D transformation.

35. The method as claimed in claim 34, wherein all of said detecting and said adapting and projecting are continuously repeated to detect each change in the position of the test object.

36. The method as claimed in claim 35, wherein the test object is manual moved in three-dimensional space.

37. The method as claimed in claim 36, further comprising:
detecting a change in position of the test object by the third detecting device using a first depth sensor camera; and
detecting an end position of the test object from a plurality of test objects last arranged on a test table by a second depth sensor camera.
